(19) United States
(12) Patent Application Publication
(10) Pub. No.: US 2025/0237006 A1
(43) Pub. Date: Jul. 24, 2025

(54) DRYER AND METHOD FOR CONTROLLING THEREOF

(71) Applicant: SAMSUNG ELECTRONICS CO., LTD., Suwon-si (KR)

(72) Inventors: Kyungmin LEE, Suwon-si (KR); Daehyun KIM, Suwon-si (KR); Junhyeong PARK, Suwon-si (KR); Jaeyong PARK, Suwon-si (KR)

(73) Assignee: SAMSUNG ELECTRONICS CO., LTD., Suwon-si (KR)

(21) Appl. No.: 19/013,971

(22) Filed: Jan. 8, 2025

Related U.S. Application Data
(63) Continuation of application No. PCT/KR2024/021471, filed on Dec. 30, 2024.

(30) Foreign Application Priority Data
Jan. 23, 2024 (KR) 10-2024-0010491

(51) Int. Cl. D06F 58/45; D06F 58/38; D06F 105/28; D06F 105/62

(52) U.S. Cl. CPC D06F 58/45; D06F 58/38; D06F 2105/28; D06F 2105/62

(57) ABSTRACT

A dryer includes a drum; a plurality of drying electrodes arranged along a circumferential surface of the drum; a plurality of sterilizing electrodes arranged along the circumferential surface of the drum between the plurality of drying electrodes; first and second RF power suppliers configured to generate RF signals, respectively; an impedance matching circuit configured to perform first impedance matching between the first RF power supplier and the plurality of drying electrodes or second impedance matching between the second RF power supplier and the plurality of sterilizing electrodes; a first switch configured to connect the impedance matching circuit to the first RF power supplier or the second RF power supplier; a second switch configured to connect the impedance matching circuit to the plurality of drying electrodes; a third switch configured to connect the impedance matching circuit to the plurality of sterilizing electrodes; and a controller.

### CROSS-REFERENCE TO RELATED APPLICATION(S)

This application is a bypass continuation application of PCT International Application No. PCT/KR2024/021471, which was filed on Dec. 30, 2024, and claims priority to Korean Patent Application No. 10-2024-0010491, filed on Jan. 23, 2024, in the Korean Intellectual Property Office, the disclosures of which are herein incorporated by reference in their entireties.

### BACKGROUND

One or more example embodiments of the disclosure relate to a dryer capable of drying an object through dielectric heating and a method of controlling the dryer.

A dryer is a device that is capable of drying an object (e.g., clothing) by removing moisture contained in the object. There are various types of drying devices capable of drying the object. For example, there is a dryer that supplies hot air into a drum that accommodates an object to dry the object. In the method of supplying hot air into the drum, heat is transferred from air having high heat to water having low heat, and thus, heat transfer efficiency is low and drying efficiency decreases accordingly. Furthermore, the hot air supplied into the drum is likely to damage the object.

In another example, there exists a dryer that is capable of drying an object through dielectric heating that uses radio frequency (RF). A related art dryer that uses the dielectric heating places the object between two flat electrodes arranged in parallel and heats water contained in the object by producing an electric field between the two flat electrodes. However, the related art dryer using the dielectric heating provides only a function to dry the object but does not provide a function to sterilize the object.

### SUMMARY

One or more example embodiments of the disclosure provide a dryer having a drying electrode for drying an object accommodated in a drum and a sterilizing electrode for sterilizing the object arranged separately to perform both a drying operation and a sterilizing operation, and a method of controlling the dryer.

One or more example embodiments of the disclosure provide a dryer capable of providing power suitable for drying an object and power suitable for sterilizing the object, and a method of controlling the dryer.

One or more example embodiments of the disclosure provide a dryer capable of maximizing an efficiency of drying an object and attaining an effect of sterilizing the object, and a method of controlling the dryer.

According to an aspect of an example embodiment of the disclosure, provided is a dryer including: a drum; a plurality of drying electrodes arranged along a circumferential surface of the drum; a plurality of sterilizing electrodes arranged along the circumferential surface of the drum between the plurality of drying electrodes; a first radio frequency (RF) power supplier and a second RF power supplier configured to generate RF signals, respectively; an impedance matching circuit configured to perform first impedance matching between the first RF power supplier and the plurality of drying electrodes or second impedance matching between the second RF power supplier and the plurality of sterilizing electrodes; a first switch configured to connect the impedance matching circuit to the first RF power supplier or the second RF power supplier; a second switch configured to connect the impedance matching circuit to the plurality of drying electrodes; a third switch configured to connect the impedance matching circuit to the plurality of sterilizing electrodes; and a controller configured to control the first RF power supplier, the second RF power supplier, the impedance matching circuit, the first switch, the second switch and the third switch to alternately perform a drying operation and a sterilizing operation.

According to an aspect of an example embodiment of the disclosure, provided is a method of controlling a dryer including: performing a drying operation by controlling the first switch, the second switch, and the third switch to connect the first RF power supplier, the impedance matching circuit, and the plurality of drying electrodes; performing a sterilizing operation by controlling the first switch, the second switch, and the third switch to connect the second RF power supplier, the impedance matching circuit, and the plurality of sterilizing electrodes; and alternately performing the drying operation and the sterilizing operation.

A dryer and a method of controlling the same according to an example of the disclosure may perform both a drying operation and a sterilizing operation by using a drying electrode and a sterilizing electrode arranged separately.

The dryer and a method of controlling the same in the disclosure may provide power suitable for drying an object and power suitable for sterilizing the object.

The dryer and a method of controlling the same in the disclosure may maximize the efficiency of drying the object and attaining an effect of sterilizing the object. Along with the sterilizing effect, a deodorization effect may also be attained.

### BRIEF DESCRIPTION OF DRAWINGS

Example embodiments of the disclosure will be more clearly understood from the following detailed description taken in conjunction with the accompanying diagrams in which:

FIG. 1 illustrates an example of a network system including various electronic devices;

FIG. 2 illustrates a dryer, according to one or more embodiments;

FIG. 3 is a cross-sectional view of a dryer, according to one or more embodiments;

FIGS. 4 and 5 illustrate layouts of electrodes, according to one or more embodiments;

FIG. 6 is a block diagram of a dryer, according to one or more embodiments;

FIG. 7 illustrates a circuit system for a drying operation and a sterilizing operation of a dryer, according to one or more embodiments;

FIGS. 8 and 9 illustrate a detailed circuit structure of the circuit system shown in FIG. 7;

FIG. 10 illustrates a circuit structure of a dryer when the dryer performs a drying operation, according to one or more embodiments;

FIG. 11 illustrates a circuit structure of a dryer when the dryer performs a sterilizing operation, according to one or more embodiments;

FIG. 12 is a graph for describing an example of how to adjust a dry time interval relating to a drying operation;

FIG. 13 is a graph for describing another example of how to adjust a dry time interval relating to a drying operation;

FIG. 14 is a flowchart describing a method of controlling a dryer, according to one or more embodiments;

FIG. 15 is a flowchart describing an example of time control for a drying operation in the method of controlling the dryer as described in FIG. 14; and

FIG. 16 is a flowchart describing another example of time control for a drying operation in the method of controlling the dryer as described in FIG. 14.

### DETAILED DESCRIPTION

It is understood that various embodiments of the disclosure and associated terms are not intended to limit technical features herein to particular embodiments, but encompass various changes, equivalents, or substitutions.

Like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

The expression “and/or” is interpreted to include a combination or any of associated elements.

The principle and embodiments of the disclosure will now be described with reference to accompanying drawings.

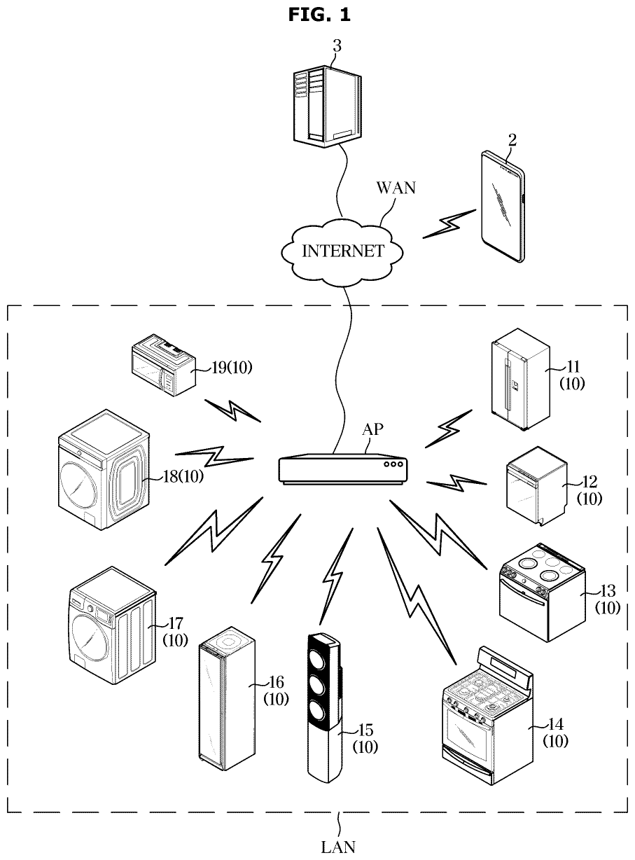

FIG. 1 illustrates an example of a network system including various electronic devices.

Referring to FIG. 1, a home appliance 10 may include a communication module (or communication interface) configured to communicate with another device such as, for example, home appliance, a user equipment 2, and/or a server 3; a user interface configured to receive a user input and/or output information to be provided the user, at least one processor configured to control an operation of the home appliance 10, and at least one memory configured to store a program for controlling operation(s) of the home appliance 10.

The home appliance 10 may be at least one of various kinds of home appliances. For example, the home appliances 10 may include at least one of a refrigerator 11, a dish washer 12, an electric range 13, an electric oven 14, an air conditioner 15, a garment care device 16, a washing device 17, a dryer 18, and/or a microwave oven 19.

The home appliance 10 is not limited to the examples are illustrated in FIG. 1. For example, the home appliances 10 may include various home appliances such as a cleaning robot, a vacuum cleaner, and/or a television, which are not shown. The aforementioned home appliances are merely an example, and in addition to the aforementioned home appliances, any device connected to another home appliance, the user equipment 2, and/or the server 3 may perform operations as will be described later may belong to the home appliance 10 according to an embodiment.

The server 3 may include a communication module (or communication interface) configured to communicate with another device such as, for example, another server, the home appliance 10 or the user equipment 2; at least one processor configured to process data received from the other device, e.g., the other server, the home appliance 10 or the user equipment 2, and at least one memory configured to store a program for processing data or storing the processed data. The server 3 may be implemented with various computing devices such as a workstation, a cloud, a data drive, a data station, etc. The server 3 may be implemented with one or more servers physically or logically classified based on a function, a sub-configuration of the function and/or data, and may transmit and/or receive data through inter-server communication and process the data.

The server 3 may perform a function, such as managing a user account, registering the home appliance 10 by associating the home appliance 10 to the user account, and managing and/or controlling the registered home appliance 10. For example, the user may access the server 3 through the user device 2 to create a user account. The user account may be identified by an identity (ID) and a password created by the user. The server 3 may register the home appliance 10 with the user account according to a set procedure. For example, the server 3 may register identification information (e.g., a serial number, a media access control (MAC) address, etc.) of the home appliance 10 in association with the user account, manage and control the home appliance 10. The user equipment 2 may include a communication module (or communication interface) configured to communicate with the home appliance 10 and/or the server 3, a user interface configured to receive a user input or output information to be provided to the user, at least one processor configured to control an operation of the use equipment 2, and at least one memory configured to store a program for controlling the operations of the user equipment 2.

The user device 2 may be carried by the user or placed at the user's home or office. The user device 2 may include a personal computer, a terminal, a portable telephone, a smart phone, a handheld device, a wearable device, etc., without being limited thereto.

In the memory of the user equipment 2, a program (e.g., an application) for controlling the home appliance 10 may be stored. The application may be sold in a state of being installed in the user device 2, or may be downloaded and installed from an external server.

The user may access the server 3 and create a user account by running the application installed in the user equipment 2, and sign up the home appliance 10 by communicating with the server 3 based on the login user account.

For example, when the home appliance 10 is operated to access the server 3 according to a procedure guided in the application installed in the user equipment 2, the server 3 may sign up the home appliance 10 with the user account by registering the identification information (e.g., a serial number or a MAC address) of the home appliance 10 in association with the user account.

The user may use the application installed in the user equipment 2 to control the home appliance 10. For example, when the user logs in on the user account with the application installed in the user equipment 2, the home appliance 10 registered with the user account may be indicated on the application, and when a control command is input for the home appliance 10, the control command may be forwarded to the home appliance 10 through the server 3.

A network may include both a wired network and a wireless network. The wired network may include a cable network and/or a telephone network, and the wireless network may include any network that transmits and/or receives signals in radio waves. The wired network and the wireless network may be connected to each other.

The network may include a wide area network (WAN) such as the Internet, a local area network (LAN) formed around an access point (AP) and/or a short-range wireless network without an AP. The short-range wireless network may include, for example, Bluetooth™ (IEEE 802.15.1), Zigbee (IEEE 802.15.4), wireless fidelity (Wi-Fi) direct, near field communication (NFC), Z-wave, etc., without being limited thereto.

The AP may connect the home appliance 10 and/or the user equipment 2 to the WAN connected to the server 3. The home appliance 10 and/or the user equipment 2 may be connected to the server 3 through the WAN.

The AP may use wireless communication such as Wi-Fi (IEEE 802.11), Bluetooth™ (IEEE 802.15.1), Zigbee (IEEE 802.15.4), etc., to communicate with the home appliance 10 or the user equipment 2, and use wired communication to access the WAN, but is not limited thereto.

In one or more embodiments, the home appliance 10 may be directly connected to the user equipment 2 and/or the server 3 without passing through the AP.

The home appliance 10 may be connected to the user equipment 2 and/or the server 3 over a long-range wireless network and/or a short-range wireless network.

For example, the home appliance 10 may be connected to the user equipment 2 over a short wireless network (e.g., Wi-Fi direct).

In another example, the home appliance 10 may use the long-range wireless network (e.g., a cellular communication module) to be connected to the user equipment 2 and/or the server 3 through the WAN.

In another example, the home appliance 10 may connect to the WAN by using wired communication, and connect to the user equipment 2 and/or the server 3 through the WAN.

When the home appliance 10 is capable of accessing the WAN through the wired communication, the home appliance 10 may operate as an AP. Accordingly, the home appliance 10 may be used to connect another home appliance to the WAN to which the server 3 is connected. Furthermore, the other home appliance may be used to connect the home appliance 10 to the WAN to which the server 3 is connected.

The home appliance 10 may transmit information about an operation and/or a status of the home appliance 10 to another home appliance, the user equipment 2, and/or the server 3 over the network. For example, on receiving a request from the server 3 or when a particular event occurs in the home appliance 10, the home appliance 10 may transmit the information about the operation and/or the status related to the request or the particular event to the other home appliance, the user equipment 2, and/or the server 3 periodically or in real time. On receiving the information about the operation and/or the status from the home appliance 10, the server 3 may update information about the operation and/or the status that has been stored, and transmit the updated information about the operation and/or the status of the home appliance 10 to the user equipment 2 over the network. The updating of the information may include various operations to change existing information such as adding new information to the existing information, replacing the existing information with new information, etc.

The home appliance 10 may obtain various information from another home appliance, the user equipment 2, and/or the server 3, and provide the obtained information to the user. For example, the home appliance 10 may obtain information about a function of the home appliance 10 (e.g., cooking instructions, washing instructions, etc.) and/or various environmental information (e.g., weather, temperature, humidity, etc.), and output the obtained information through the user interface.

The home appliance 10 may operate according to a control command received from an external device, e.g., another home appliance, the user equipment 2, and/or the server 3. For example, when the home appliance 10 receives a prior approval of the user to operate according to a control command of the server 3 even without a user input, the home appliance 10 may operate according to the control command received from the server 3. The control command received from the server 3 may include a control command input by the user through the user device 2, a control command based on a preset condition or the like, without being limited thereto.

The user equipment 2 may transmit information about the user to the home appliance 10 and/or the server 3 through the communication module. For example, the user device 2 may transmit information about a location of the user, a physical condition of the user, a preference of the user, a schedule of the user, etc., to the server 3. The user device 2 may transmit the information about the user to the server 3 according to prior approval of the user on transmitting such information.

The home appliance 10, the user equipment 2, and/or the server 3 may determine a control command by using a technology such as artificial intelligence (AI). For example, the server 3 may receive information about the operation and/or the status of the home appliance 10 and/or receive information about the user of the user equipment 2, process the information by using a technology such as AI, and transmit a result of the processing and/or a control command to the home appliance 10 and/or the user equipment 2 based on the result of the processing.

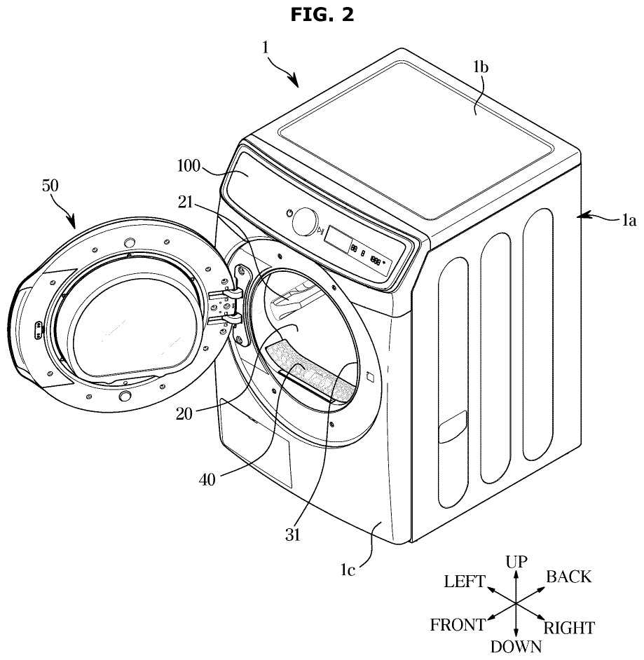

FIG. 2 illustrates a dryer, according to one or more embodiments.

A dryer 1 as will be described below with reference to FIG. 2 may correspond to the aforementioned home appliance 10 shown in FIG. 1.

Referring to FIG. 2, the dryer 1 may include a cabinet 1a that defines an exterior, and a drum 20 rotationally installed in the cabinet 1a. The cabinet 1a may be provided in a shape of substantially a hexahedron. The cabinet 1a may include a top cover 1b that provides a top portion of the cabinet 1a, a front cover 1c that provides a front portion thereof, and a base that provides a bottom portion thereof.

For example, the front cover 1c, the top cover 1b, and the base, which constitute at least a part the cabinet 1a, may be separately provided and assembled together. In another example, some components (e.g., the front cover, the top cover and base) that constitute at least a part of the cabinet 1a may be integrally formed.

An inlet 31 through which to throw in or take out an object (e.g., clothing (not shown)) to or from the drum 20 may be provided at the front portion (e.g., front cover 1c) of the cabinet 1a. The dryer 1 may include a door 50 configured to open or close the inlet 31 provided at the front cover 1c. The user may throw in or take out the object to or from the drum 20 through the inlet 31 after opening the door 50. When the inlet 31 is closed and the dryer 1 starts to operate, a door lock may lock the door 50.

A user interface 100 may be provided in an upper portion on the front surface of the cabinet 1a for interaction between the user and the dryer 1. The user interface 100 may obtain a user input and display various information about the dryer 1. A position of the user interface 100 may not be limited to the front surface. The user interface 100 may be provided in various position(s) on the dryer 1.

The user interface 100 may include a display. The user interface 100 may also include an input module (or input interface) configured to obtain a user input relating to an operation of the dryer 1. The input module may include a rotatable dial and various buttons. In addition, the user interface 100 may include various types of input modules and a display.

The display may be provided as various types of display panels. For example, the display may include a liquid crystal display (LCD) panel, a light emitting diode (LED) panel, an organic LED (OLED) panel, or a micro LED panel. The display may include a touch screen to be used as an input device as well.

The display may display information input by the user or information to be provided for the user in various screens. The display may display information regarding an operation of the dryer 1 in at least one of an image or a text. The display may also display a graphic user interface (GUI) that enables control of the dryer 1. Specifically, the display may display a user interface element (UI element) such as an icon.

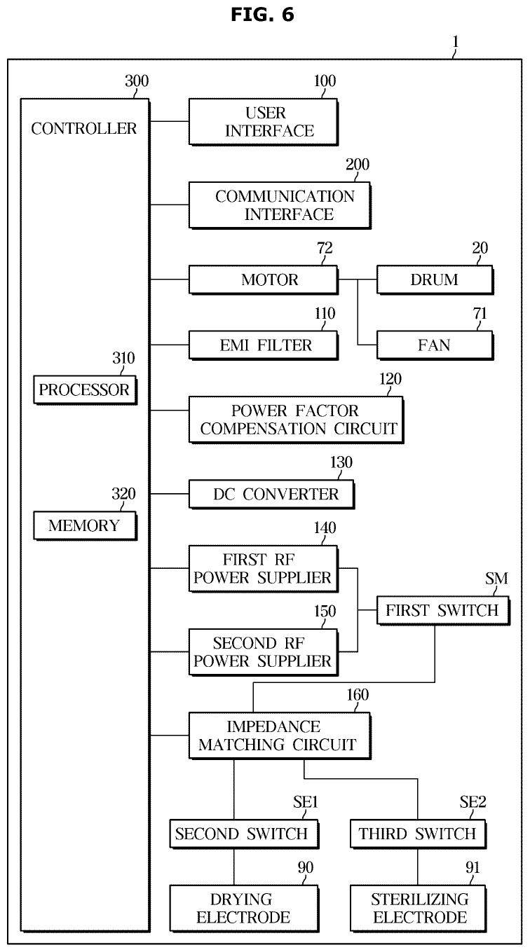

The input module may transmit an electrical signal (e.g., voltage or current) corresponding to a user input to a controller 300 of the dryer 1 (see FIG. 6). The input module may include various buttons and/or a dial. For example, the input module may include at least one of a power button to power on or off the dryer 1, a start/stop button to start or stop a drying operation, a dry mode button to select a dry mode, a temperature button to set a dry temperature, a time button to set a dry time, etc. These various buttons may be provided as mechanical buttons and/or touch buttons.

The dial included in the input module may be rotationally provided. The UI elements displayed on the display may be sequentially shifted by turning the dial. The dryer 1 may perform drying according to a selected dry mode. The dry mode may include dry parameters such as dry temperature and dry time. Other dry modes may be selected depending on a position of the object, a type of the object, and/or an amount of the object in the drum 20.

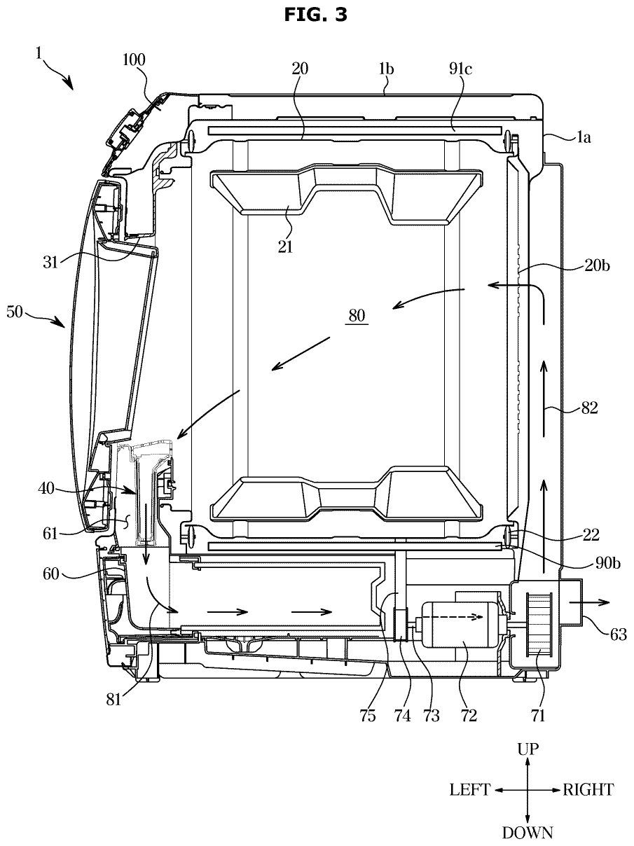

The dryer 1 may include a filter 40 detachably installed at the front cover 1c. The filter 40 may filter off a foreign substance such as lint that moves along with air circulating in the drum 20. The dryer may include a lifter 21, which will be described below with reference to FIG. 3.

FIG. 3 is a cross-sectional view of a dryer, according to one or more embodiments.

Referring to FIG. 3, the drum 20 of a cylindrical shape may be provided in the cabinet 1a. The drum 20 may be configured to accommodate and dry the object. The drum 20 may be configured to rotate by receiving power from a motor 72. The drum 20 may be provided in the cabinet 1a to rotate around a rotating axis arranged in almost parallel with the ground.

The lifter 21 may be provided on an inner circumferential surface of the drum 20 to lift the object while the drum 20 is rotating. An operation in which the object is lifted by the lifter 21 and then falls may be repeated according to a rotation speed of the drum 20. A roller 22 that supports the drum 20 to be smoothly rotated may be provided on an outer circumferential surface of the drum 20.

A driving device may be provided in a lower portion in the cabinet 1a. The driving device may be mounted on the base of the dryer 1. The driving device may include the motor 72, and a pulley 74 and a belt 75 configured to transfer power received from the motor 72 to the drum 20.

The pulley 74 may be connected to a rotation shaft 73, which is connected to the motor 72. When the rotation shaft 73 is rotated by the motor 72, the pulley 74 may be rotated along with the rotation shaft 73. The belt 75 may be installed to be wound on an outer surface of the pulley 74 and an outer surface of the drum 20. When the belt 75 is rotated by driving power of the motor 72, the drum 20 may be rotated along with the belt 75. The drum 20 may be rotated clockwise or counterclockwise.

A flow path 80 may be formed in the cabinet 1a and in the drum 20 in which air is circulated. The flow path 80 may include an air discharge path 81 in which air is discharged out of the drum 20 from inside the drum 20, and an air supply path 82 in which air is supplied into the drum 20.

The dryer 1 may include a discharge duct 60 that forms the air discharge path 81. The filter 40 may be provided at an inlet 61 of the discharge duct 60. The discharge duct 60 may pass through the cabinet 1a, and an outlet 63 of the discharge duct 60 may be exposed to an outside of the cabinet 1a. The air flowing in through the inlet 61 of the discharge duct 60 may be filtered while passing the filter 40. The filter 40 may filter out a foreign substance such as lint contained in the air.

A fan 71 may be provided in the cabinet 1a to circulate the air. The air may flow into the discharge duct 60 from inside the drum 120 due to rotation of the fan 71. Furthermore, due to the rotation of the fan 71, air may be supplied into the drum 20 through the air supply path 83 and an air inlet 20b of the drum 20. The air supplied into the drum 20 may be used for drying the object.

The motor 72 may rotate not only the drum 20 but also the fan 71. The drum 20 and the fan 71 are shown as being driven by the single motor 72 in FIG. 3, but are not limited thereto. An extra fan motor (not shown) for driving the fan 71 may be included. Furthermore, the motor 72 may be directly connected to the drum 20 to rotate the drum 20. When the motor 72 is directly connected to the drum 20, the pulley 74 and the belt 75 may be omitted.

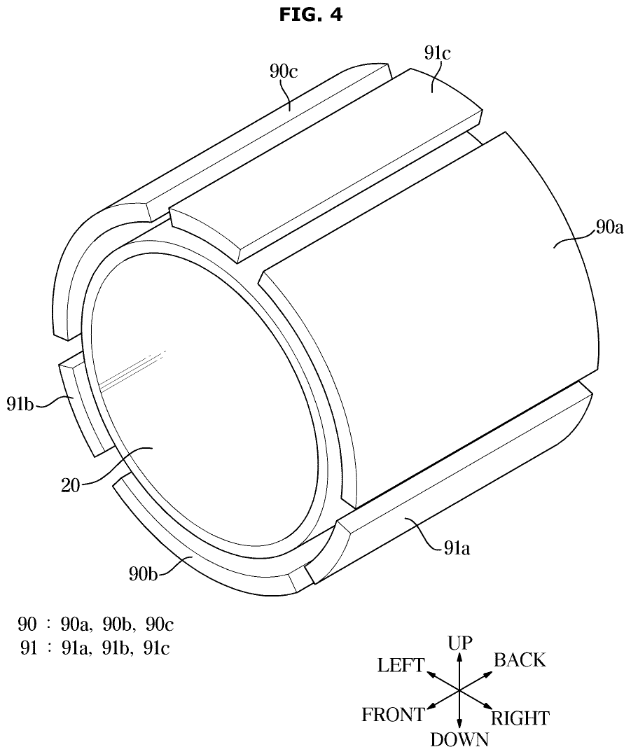

A plurality of electrodes may be provided between the cabinet 1a and the drum 20. For example, a drying electrode 90a (see FIG. 4) and a sterilizing electrode 91c may be provided between the cabinet 1a and the drum 20. The drying electrode 90a and the sterilizing electrode 91c may be arranged along a circumference of the drum 20 to be separated from each other. The drying electrode 90a and the sterilizing electrode 91c may be alternately arranged. The drying electrode 90a and the sterilizing electrode 91c may be arranged to be separated even from the cabinet 1a and the drum 20.

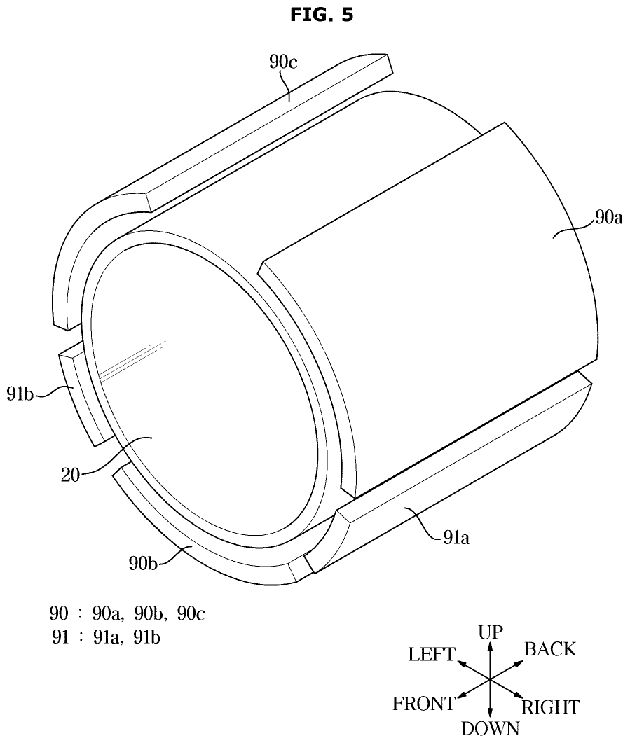

FIGS. 4 and 5 illustrate layouts of electrodes, according to one or more embodiments.

Referring to FIGS. 4 and 5, a plurality of drying electrodes 90 and a plurality of sterilizing electrodes 91 may be alternately arranged along the circumference of the drum 20. The plurality of drying electrodes 90 and the plurality of sterilizing electrodes 91 may be spaced from one another. Each of the plurality of drying electrodes 90 and the plurality of sterilizing electrodes 91 may have a form of a curved plate. The plurality of drying electrodes 90 may be separately placed along the outer circumferential surface of the drum 20. The plurality of sterilizing electrodes 91 may be placed along the outer circumferential surface of the drum 20 between the plurality of drying electrodes 90.

The plurality of drying electrodes 90 and the plurality of sterilizing electrodes 91 may be fixed between the cabinet 1a and the drum 20. The drum 20 may not be connected to the drying electrodes 90 and the sterilizing electrodes 91. Hence, the drying electrodes 90 and the sterilizing electrodes 91 may not restrict the rotation of the drum 20. Furthermore, as the drying electrode 90 and the sterilizing electrode 91 are arranged along the circumference of the drum 20, the drying electrode 90 and the sterilizing electrode 91 may produce electric fields in various areas in the drum 20. Accordingly, the dryer 1 according to an embodiment of the disclosure may produce the electric fields in the drum 20 through the drying electrodes 90 and the sterilizing electrodes 91, and dry and sterilize the object while the drum 20 is rotating.

For example, as shown in FIG. 4, a first drying electrode 90a, a second drying electrode 90b, and a third drying electrode 90c (collectively, 90) and a first sterilizing electrode 91a, a second sterilizing electrode 91b, and a third sterilizing electrode 91c (collectively, 91) may be arranged along the circumference of the drum 20. The first drying electrode 90a may be provided on an upper right position relative to the drum 20. The second drying electrode 90b may be provided on a lower position of the drum 20 (e.g., under the drum 20) to be adjacent to the first drying electrode 90a. The third drying electrode 90c may be provided on an upper left position relative to the drum 20 to be adjacent to the first drying electrode 90a.

The first sterilizing electrode 91a may be provided between the first drying electrode 90a and the second drying electrode 900b. The second sterilizing electrode 91b may be provided between the second drying electrode 90b and the third drying electrode 90c. The third sterilizing electrode 91c may be provided between the first drying electrode 90a and the third drying electrode 90c. Based on a layout of the drying electrodes 90 and the sterilizing electrodes 91, drying and sterilizing of the object may be possible in an entire area in the drum 20.

Referring to FIG. 5, it is also possible to exclude the third sterilizing electrode 91c and provide only the first sterilizing electrode 91a and the second sterilizing electrode 91b. In other words, no sterilizing electrode may be provided between the first drying electrode 90a and the third drying electrode 90c. During the rotation of the drum 20, the object moving in the drum 20 stays longer in a lower space in the drum 20 due to the gravity. Hence, the object may be sterilized only based on the first sterilizing electrode 91a provided between the first drying electrode 90a and the second drying electrode 90b and the second sterilizing electrode 91b provided between the second drying electrode 90b and the third drying electrode 90c.

Numbers and layouts of the drying electrodes 90 and the sterilizing electrodes 91 are not limited to the examples shown in FIGS. 4 and 5. The number of each of the drying electrodes 90 and the sterilizing electrodes 91 may be any number, e.g., one or more, or three or more.

The sterilizing electrode 91 may be smaller in size than the drying electrode 90. For example, each of the plurality of drying electrodes 90 has a first area larger than a second area of each of the plurality of sterilizing electrodes 91. Furthermore, each of the plurality of drying electrodes 90 has a first thickness greater than a second thickness of each of the plurality of sterilizing electrodes 91. With a greater thickness of the drying electrode 90 than that of the sterilizing electrode 91, drying efficiency may increase. In general, more energy and time is required for drying the object than for sterilizing the object. A relatively larger area of the drying electrode 90 may mean a wider area in which electric fields are produced during the drying operation. A relatively greater thickness of the drying electrode 90 may increase a strength of the electric fields produced during the drying operation.

An attribute of power required for drying may be different from an attribute of power required for sterilizing. To attain a drying effect using an electrode, a relatively low voltage and a relatively high current need to be applied to the electrode. On the other hand, to attain a sterilizing effect using an electrode, a relatively high voltage and a relatively small current need to be applied to the electrode. Hence, by using the same electrode and the same circuit, both the drying effect and sterilizing effect may not be attained.

In an embodiment of the disclosure, the dryer 1 may have the drying electrode 90 and the sterilizing electrode 91 arranged separately, and have a circuit structure to supply power that is suitable for the drying electrode 90 and power that is suitable for the sterilizing electrode 91. The dryer 1 may apply a relatively low voltage and a relatively high current to the drying electrode 90. The dryer 1 may apply a relatively high voltage and a relatively small current to the sterilizing electrode 91. When power is supplied to each of the drying electrode 90 and the sterilizing electrode 91, an electric field may be produced inside the drum 20.

The electric field produced inside the drum 20 by the drying electrode 90 may vibrate dielectrics (e.g., water molecules) contained in the object. When the dielectrics (e.g., water molecules) vibrate, dipole frictional heat may be generated, thereby heating the dielectrics. When the heated dielectrics evaporate, the object may be dried. The evaporated dielectrics may be discharged out of the drum 20 along with the air supplied into the drum 20.

The electric field produced inside the drum 20 by the sterilizing electrode 91 may remove microorganisms such as germs by destroying cell membranes of the microorganisms. When a strong electric field is applied to the microorganisms, a potential difference between cell membranes increases, and as charges generated on both surfaces of the cell membrane are opposite, there may be an attraction between the charges on both surfaces. The attraction may compress the cell membrane and reduce a thickness of the membrane. When the thickness of the cell membrane is reduced, pores may be formed on the cell membrane, destroying the cell membrane such that the germs become extinct. The electric field produced by the sterilizing electrode 91 even for a short period of time may be effective in sterilization.

The electric field produced by the sterilizing electrode 91 inside the drum 20 may also deodorize the object. When a relatively high voltage is applied to the sterilizing electrode 91, corona discharge may occur. A discharge phenomenon that occurs when gas particles on electrode surfaces are excited and ionized due to the high voltage applied between two electrodes is called the corona discharge. When the object (e.g., clothing) containing odor particles is exposed to a high-voltage electric field, the odor particles may be separated from the object due to the corona discharge phenomenon. The object may be deodorized accordingly.

FIG. 6 is a block diagram of a dryer, according to one or more embodiments. An operation of the dryer 1 will now be described in detail.

Referring to FIG. 6, the dryer 1 may include a circuit system configured to perform a drying operation and a sterilizing operation. For example, the dryer 1 may include an electro magnetic interference (EMI) filter 110, a power factor compensation circuit 120, a direct current (DC) converter 130, a first radio frequency (RF) power supplier 140, a second RF power supplier 150, an impedance matching circuit 160, a first switch SM, a second switch SE1, a third switch SE2, the drying electrode 90, the sterilizing electrode 91, and the controller 300. Furthermore, the dryer 1 may include the motor 72 for rotating the drum 20 and the fan 71, the user interface 100 and a communication interface 200.

The user interface 100 may obtain a user input and display various information about the operation of the dryer 1. The user interface 100 may include an input module (or input interface) configured to obtain a user input and a display configured to display information. The user interface 100 may further include an output interface configured to output information (e.g., speaker configured to output sound).

The user interface 100 may display operation information of the dryer 1. For example, the user interface 100 may display a dry mode, a dry temperature, an expected dry time and/or a time left until the end of the drying. The dry mode may include dry settings (e.g., a dry level, an extra time for wrinkle free, and a dry time) determined in advance depending on the object's type (e.g., shirts, bedclothes, or underwear) and material (e.g., cotton or wool). For example, standard dry may include a dry setting that may be applied to most objects to be dried, and bedclothes dry may include a dry setting optimized for drying bedclothes. The dry settings of the dry mode may include a sterilization time and a sterilization intensity.

The user interface 100 may also display a sterilization mode separately from the dry settings. The user may operate the user interface 100 to select the sterilization mode. When the sterilization mode is selected, the dryer 1 may perform a sterilizing operation together with or separately from the drying operation.

The communication interface 200 may perform a communication with at least one of the user equipment 2, and/or the server 3 over a network. The controller 300 may obtain various information, various signals and/or various data from the user equipment 2, and/or the server 3 through the communication interface 200. For example, the communication interface 200 may receive a remote control signal from the user equipment 2. The controller 300 may obtain firmware and/or software for operation of the dryer 1 from the server 3 through the communication interface 200.

The communication interface 200 may include various communication circuits. The communication interface 200 may include a wireless communication circuit and/or a wired communication circuit. For example, a communication circuit that supports wireless communication schemes such as wireless LAN, home RF, infrared communication, ultra-wide band (UWB) communication, Wi-Fi, Bluetooth™ and Zigbee may be provided.

The controller 300 may be electrically connected to the components of the dryer 1 to control the components of the dryer 1. For example, the controller 300 may control the motor 72 to rotate the drum 20 and the fan 71. The controller 300 may control the EMI filter 110, the power factor compensation circuit 120, the DC converter 130, the first RF power supplier 140, the second RF power supplier 150, the impedance matching circuit 160, the first switch SM, the second switch SE1, and the third switch SE2 to supply power to each of the drying electrode 90 and the sterilizing electrode 91.

The controller 300 may include a processor 310 and a memory 320. The memory 320 may include a volatile memory (e.g., a static random access memory (S-RAM) or a dynamic RAM (D-RAM)) and a non-volatile memory (e.g., a read-only memory (ROM) or an erasable programmable ROM (EPROM)). The processor 310 and the memory 320 may be implemented in separate chips or in a single chip. Furthermore, there may be a plurality of processors and a plurality of memories. The processor 310 may process various data and various signals based on instructions, data, a program and/or software stored in the memory 320. The processor 310 may generate control signals to control the components of the dryer 1. The processor 310 may include one or multiple cores.

The EMI filter 110 may remove noise contained in alternating current (AC) power supplied from a commercial power source AC. The EMI filter 110 may be provided as a circuit in which various electrical elements such as capacitors, inductors, and/or diodes are electrically connected in parallel and/or series. The EMI filter 110 may discharge the noise contained in the AC power through a ground wire. The EMI filter 110 may be provided as a passive filter or an active filter.

The power factor compensation circuit 120 may compensate a power factor of the AC power. The power factor compensation circuit 120 may compensate the power factor by removing reactive power from among effective power and the reactive power which constitute the AC power. The compensating of the power factor may reduce power loss. The power factor compensation circuit 120 may be provided as a circuit in which various electrical elements such as capacitors, inductors, and/or diodes are electrically connected in parallel and/or series. The power factor compensation circuit 120 may be controlled by the controller 300.

The DC converter 130 may convert the power output from the power factor compensation circuit 120 to DC power that is suitable for the first RF power supplier 140 and the second RF power supplier 150. The DC converter 130 may transmit the converted DC power to the first RF power supplier 140 and the second RF power supplier 150. The DC converter 130 may be provided as a circuit in which various electrical elements such as transistors, inductors, and/or diodes are electrically connected in parallel and/or series.

The controller 300 may control the DC converter 130 to adjust a magnitude of the voltage applied to the drying electrode 90 and/or the sterilizing electrode 91. When the power supplied to the first RF power supplier 140 and the second RF power supplier 150 increases, an amplitude of the RF signal may increase and the magnitude of the voltage applied to the drying electrode 90 and/or the sterilizing electrode 91 may increase. The magnitude of the voltage may be represented by an effective value.

The first RF power supplier 140 may generate an RF signal and apply the RF signal to the drying electrode 90. Sinusoidal power may be applied to the drying electrode 90 due to the RF signal. The controller 300 may control the first RF power supplier 140 to adjust RF power applied to the drying electrode 90. When the RF power is supplied to the drying electrode 90, an electric field may be produced in the drum 20 for dielectric heating of the object.

A phase of the RF power applied to each of the plurality of drying electrodes 90 may be different. As the RF power having different phases is applied to the plurality of drying electrodes 90, a rotating electric field may be produced in the drum 20. In other words, a strength of the electric field produced between two neighboring drying electrodes 90 may repeatedly increase and decrease periodically.

The second RF power supplier 150 may generate an RF signal and apply the RF signal to the sterilizing electrode 91. Sinusoidal power may be applied to the sterilizing electrode 91 due to the RF signal. The controller 300 may control the second RF power supplier 150 to adjust RF power applied to the sterilizing electrode 91. When the RF power is supplied to the sterilizing electrode 91, an electric field may be produced in the drum 20 for sterilizing the object.

A phase of the RF power applied to each of the plurality of sterilizing electrodes 91 may be different. As the RF power having different phases is applied to the plurality of sterilizing electrodes 91, a rotating electric field may be produced in the drum 20. In other words, a strength of the electric field produced between two neighboring sterilizing electrodes 91 may repeatedly increase and decrease periodically.

The controller 300 may control the first RF power supplier 140 such that a relatively low voltage and a relatively high current are applied to the drying electrode 90. The controller 300 may control the second RF power supplier 150 such that a relatively high voltage and a relatively small current are applied to the sterilizing electrode 91. The voltage applied to the drying electrode 90 may be referred to as a first voltage. The current applied to the drying electrode 90 may be referred to as a first current. The voltage applied to the sterilizing electrode 91 may be referred to as a second voltage. The current applied to the sterilizing electrode 91 may be referred to as a second current. The first voltage may be lower than the second voltage. The first current may be greater in magnitude than the second current.

The impedance matching circuit 160 may be provided between the first RF power supplier 140 and the drying electrode 90 and between the second RF power supplier 150 and the sterilizing electrode 91. The RF signal generated by the first RF power supplier 140 may be provided to the drying electrode 90 through the impedance matching circuit 160. The RF signal generated by the second RF power supplier 150 may be provided to the sterilizing electrode 91 through the impedance matching circuit 160.

The impedance matching circuit 160 may match output impedance of the RF power supplier 140 or 150 and electrode impedance of each of the electrodes 90 and 91. The impedance matching circuit 160 may match the output impedance of the first RF power supplier 140 and the electrode impedance of the drying electrode 90. The impedance matching circuit 160 may match the output impedance of the second RF power supplier 150 and the electrode impedance of the sterilizing electrode 91.

When there is a difference between the output impedance of the RF power supplier 140 or 150 and the electrode impedance of the electrode 90 or 91, reflected power may be generated from the electrode 90 or 91 and power transmission efficiency may be reduced. To minimize the reflected power, the output impedance of the RF power supplier 140 or 150 and the electrode impedance of the electrode 90 or 91 needs to be matched. The controller 300 may control the impedance matching circuit 160 to perform impedance matching.

The controller 300 may determine the electrode impedance of the drying electrode 90 or the electrode impedance of the sterilizing electrode 91 based on the magnitude of a voltage detected at an output end of the impedance matching circuit 160. As the drying electrode 90 and the sterilizing electrode 91 have different sizes, the electrode impedance of the drying electrode 90 may be different from the electrode impedance of the sterilizing electrode 91. Hence, impedance matching for the drying electrode 90 and impedance matching for the sterilizing electrode 91 need to be performed separately. The controller 300 may control the impedance matching circuit 160 to perform first impedance matching between the first RF power supplier 140 and the drying electrode 90 or second impedance matching between the second RF power supplier 150 and the sterilizing electrode 91.

The electrode impedance of each of the drying electrode 90 and the sterilizing electrode 91 may vary depending on various factors such as an amount of the object accommodated in the drum 20, a type of the object, a size of the object, an amount of water contained in the object, a distribution of the object, and/or the like. For example, when there are dielectrics (e.g., water) having a high dielectric constant between the plurality of electrodes 90 and 91, charges may be accumulated on the dielectrics, and thus, a strength of the electric field formed between the electrodes 90 and 91 may be reduced. When the strength of the electric field is reduced, the magnitude of the voltage detected from the electrode 90 or 91 may be reduced and the electrode impedance may be reduced. As the water contained in the object is reduced and/or removed with a progress of drying of the object, ever increasing electrode impedance may be detected.

In other words, as the drying proceeds, the difference between the magnitude of the voltage detected from the drying electrode 90 and/or the sterilizing electrode 91 and the magnitude of a reference voltage may be gradually reduced. The controller 300 may determine a level of dryness of the object based on a change in a magnitude of the voltage detected from the drying electrode 90 and/or the sterilizing electrode 91 and/or a change in electrode impedance. The controller 300 may determine completion of the drying based on the level of dryness of the object reaching within a tolerance range of a preset reference dryness level. Furthermore, the controller 300 may determine completion of the drying when the electrode impedance of the drying electrode 90 and/or the sterilizing electrode 91 is greater than or equal to a preset threshold.

The electrode impedance detected from each of the plurality of electrodes 90 and 91 may be different depending on the position of the object in the drum 20. The controller 300 may obtain information about a distribution of the object based on the electrode impedance of each of the plurality of electrodes 90 and 91. Furthermore, the controller 300 may determine an amount of the water (e.g., moisture content) contained in the object based on the detected electrode impedance.

The first switch SM may electrically connect the impedance matching circuit 160 to the first RF power supplier 140 or the second RF power supplier 150. The controller 300 may be electrically connected to the first switch SM to control the first switch SM. According to switching of the first switch SM, the first RF power supplier 140 may be electrically connected to the impedance matching circuit 160 or the second RF power supplier 150 may be electrically connected to the impedance matching circuit 160.

The first switch SM may be referred to as a mode switching switch. The controller 300 may control the first switch SM to switch an operation mode of the dryer 1 to the dry mode or the sterilization mode. The dryer 1 may perform a drying operation corresponding to the dry mode. The dryer 1 may perform a sterilizing operation corresponding to the sterilization mode.

The second switch SE1 may electrically connect the impedance matching circuit 160 to the drying electrode 90. The controller 300 may be electrically connected to the second switch SE1 to control the second switch SE1. When the second switch SE1 is closed, the impedance matching circuit 160 is electrically connected to the drying electrode 90. When the second switch SE1 is open, the impedance matching circuit 160 is disconnected from the drying electrode 90. The second switch SE1 may be referred to as a drying electrode switch.

The third switch SE2 may electrically connect the impedance matching circuit 160 to the sterilizing electrode 91. The controller 300 may be electrically connected to the third switch SE2 to control the third switch SE2. When the third switch SE2 is closed, the impedance matching circuit 160 is electrically connected to the sterilizing electrode 91. When the third switch SE2 is open, the impedance matching circuit 160 is disconnected from the sterilizing electrode 91. The third switch SE2 may be referred to as a sterilizing electrode switch.

The second switch SE1 and the third switch SE2 are illustrated as being arranged separately, but the disclosure is not limited thereto. For example, the second switch SE1 and the third switch SE2 may be provided as a single electrode selecting switch. In this case, according to switching of the electrode selecting switch, the impedance matching circuit 160 may be connected to the drying electrode 90 or the impedance matching circuit 160 may be connected to the sterilizing electrode 91.

The controller 300 may alternately perform the drying operation for drying the object in the drum 20 and the sterilizing operation for sterilizing the object. To alternately perform the drying operation and the sterilizing operation, the controller 300 may control the first RF power supplier 140, the second RF power supplier 150, the impedance matching circuit 160, the first switch SM, the second switch SE1 and the third switch SE2.

The controller 300 may alternately perform the drying operation and the sterilizing operation multiple times. A total operation time of the dryer 1 may be divided into a dry time and a sterilization time. The dry time may indicate a sum of dry time intervals of the plurality of drying operations. The sterilization time may indicate a sum of sterilization time intervals of the plurality of sterilizing operations. The sterilization time interval may be kept constant. The dry time may be set to be longer than the sterilization time to maximize the dry efficiency.

The controller 300 may adjust the dry time interval for each of the plurality of drying operations while alternately performing the plurality of drying operations and the plurality of sterilizing operations. For example, the controller 300 may linearly or non-linearly reduce the dry time interval during a preset intensive dry time, and keep the dry time interval constant based on a lapse of the preset intensive dry time. In another example, the controller 300 may keep the dry time interval constant during the preset intensive dry time, and reduce the dry time interval based on the lapse of the preset intensive dry time.

When the dryer 1 starts a first drying operation, the object may be dried relatively fast, and after a certain time, drying of the object may relatively slow down. In other words, moisture content of the object may be rapidly reduced at a beginning of the drying, and as the drying proceeds, a change in the moisture content of the object may decrease. In the disclosure, the dryer 1 may increase both the drying efficiency and the sterilization efficiency by adjusting the dry time interval with consideration for the change in moisture content of the object.

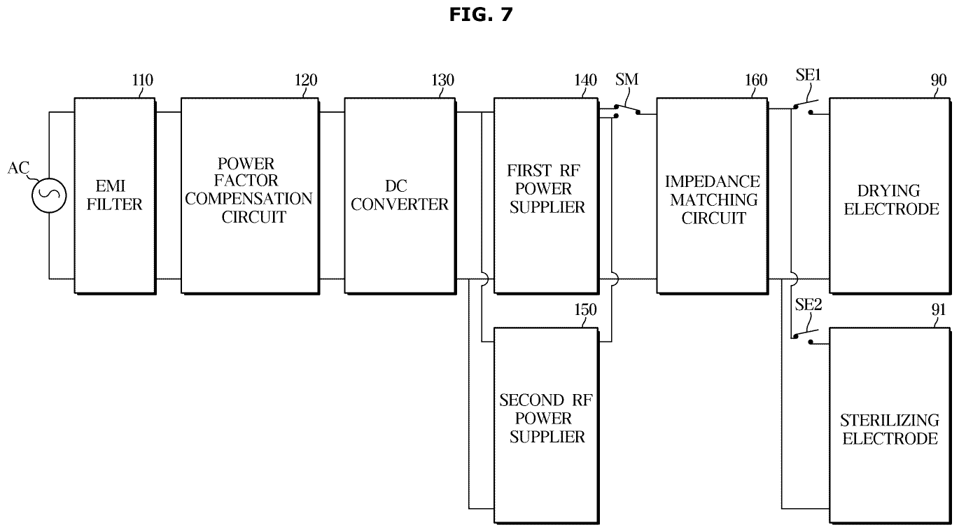

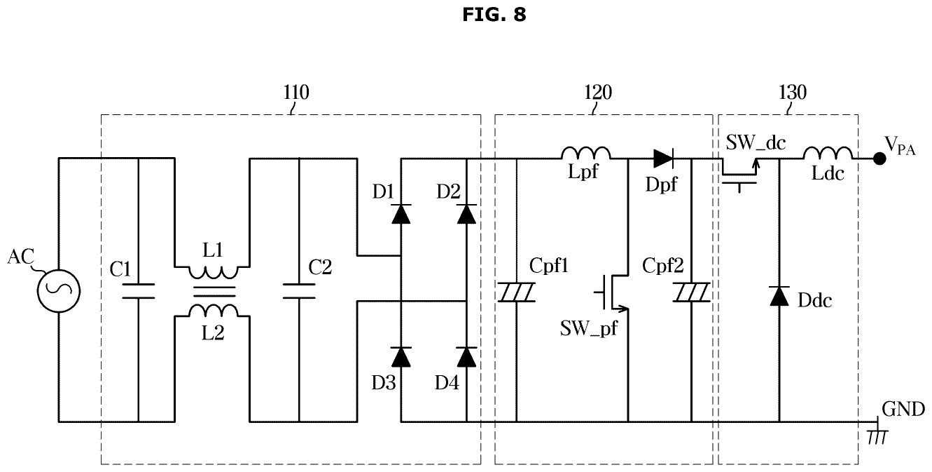

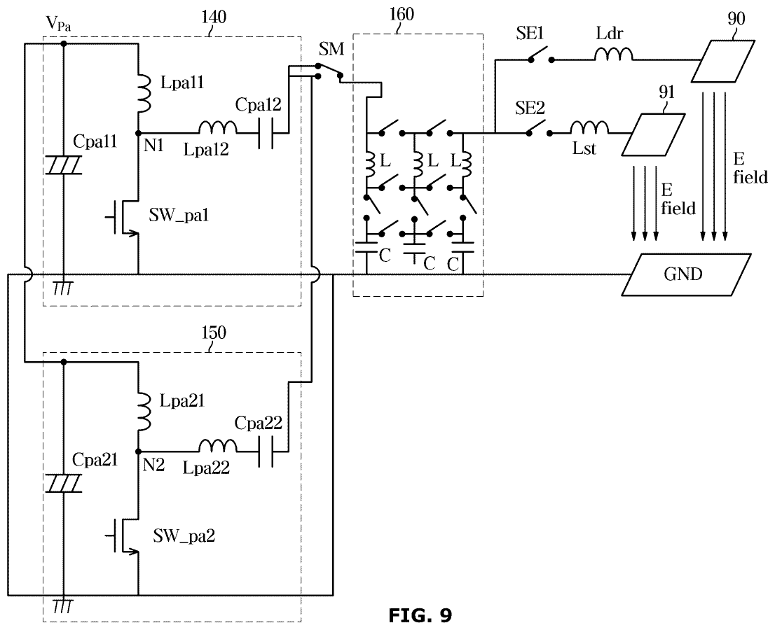

FIG. 7 illustrates a circuit system for a drying operation and a sterilizing operation of a dryer, according to one or more embodiments. FIGS. 8 and 9 illustrate a detailed circuit structure of the circuit system shown in FIG. 7.

Referring to FIGS. 7, 8 and 9, the EMI filter 110 may be connected to the commercial power source AC and may remove noise of AC power supplied from the commercial power source AC. The EMI filter 110 may provide AC power, from which the noise is removed, to the power factor compensation circuit 120. The EMI filter 110 may be provided as a circuit in which various components are electrically connected in parallel and/or series. For example, the EMI filter 110 may include a plurality of capacitors C1 and C2 connected in parallel, a plurality of inductors L1 and L2 which implement a transformer, and a plurality of diodes D1, D2, D3 and D4 that form a bridge. The circuit structure of the EMI filter 110 is not limited to the example illustrated herein. The circuit structure of the EMI filter 110 may be configured in various ways depending on the design.

The power factor compensation circuit 120 may compensate the power factor of the AC power provided from the EMI filter 110. The power factor compensation circuit 120 may provide the power with the compensated power factor to the DC converter 130. The power factor compensation circuit 120 may be provided as a circuit in which various components are electrically connected in parallel and/or series. For example, the power factor compensation circuit 120 may include a plurality of electrolytic capacitors Cpf1 and Cpf2, an inductor Lpf, a diode Dpf and a switching device SW_pf. The switching device SW_pf may correspond to a transistor. The transistor may allow or block a flow of a current depending on application of a voltage thereto. The circuit structure of the power factor compensation circuit 120 is not limited to the example illustrated herein. The circuit structure of the power factor compensation circuit 120 may be configured in various ways depending on the design.

The DC converter 130 may convert the power output from the power factor compensation circuit 120 to DC power. The DC converter 130 may transmit the converted DC power to the first RF power supplier 140 and the second RF power supplier 150. The DC converter 130 may be provided as a circuit in which various components are electrically connected in parallel and/or series. For example, the DC converter 130 may include a switching device SW_dc, an inductor Ldc, and a diode Ddc. The switching device SW_dc may correspond to a transistor. The circuit structure of the DC converter 130 is not limited to the example illustrated herein. The circuit structure of the DC converter 130 may be configured in various ways depending on the design.

The first RF power supplier 140 may be provided as a circuit that includes various elements for generating an RF signal. For example, the first RF power supplier 140 may include an electrolytic capacitor Cpa11, a capacitor Cpa12, a plurality of inductors Lpa11 and Lpa12 and a switching device SW_pa1. The electrolytic capacitor Cpa11 may connect a node Vpa to the ground GND. The switching device SW_pa1 and the inductor Lpa11 may be connected in series between the node Vpa and the ground GND. The inductor Lpa12 and the capacitor Cpa12 connected in series may be provided between a node N1, at which the switching device SW_pa1 is connected to the inductor Lpa11, and the first switch SM.

The switching device SW_pa1 of the first RF power supplier 140 may correspond to a transistor, and may be referred to as a first switching device. The controller 300 may control the switching device SW_pa1 to activate or deactivate the first RF power supplier 140. The controller 300 may control an operation of the first RF power supplier 140 by adjusting a voltage applied to the switching device SW_pa1. When the switching device SW_pa1 is turned on, the operation of the first RF power supplier 140 may be activated. When the switching device SW_pa1 is turned off, the operation of the first RF power supplier 140 may be deactivated.

The circuit structure of the second RF power supplier 150 may be equal to the circuit structure of the first RF power supplier 140. For example, the second RF power supplier 150 may include an electrolytic capacitor Cpa21, a capacitor Cpa22, a plurality of inductors Lpa21 and Lpa22 and a switching device SW_pa2. The electrolytic capacitor Cpa21 may connect the node Vpa to the ground GND. The switching device SW_pa2 and the inductor Lpa21 may be connected in series between the node Vpa and the ground GND. The inductor Lpa22 and the capacitor Cpa22 connected in series may be provided between a node N2, at which the switching device SW_pa2 is connected to the inductor Lpa21, and the first switch SM.

The switching device SW_pa2 of the second RF power supplier 150 may correspond to a transistor, and may be referred to as a second switching device. The controller 300 may control the switching device SW_pa2 to activate or deactivate the second RF power supplier 150. The controller 300 may control an operation of the second RF power supplier 150 by adjusting a voltage applied to the switching device SW_pa2. When the switching device SW_pa2 is turned on, the operation of the second RF power supplier 150 may be activated. When the switching device SW_pa2 is turned off, the operation of the second RF power supplier 150 may be deactivated.

The controller 300 may activate the first RF power suppler 140 and deactivate the second RF power supplier 150 during the drying operation. The controller 300 may deactivate the first RF power suppler 140 and activate the second RF power supplier 150 during the sterilizing operation.

The first switch SM may be connected to an output end of the first RF power supplier 140 or an output end of the second RF power supplier 150. The first switch SM may also be connected to the impedance matching circuit 160. The first switch SM may connect the impedance matching circuit 160 to the first RF power supplier 140 or the second RF power supplier 150.

The controller 300 may control the first switch SM to connect the first RF power supplier 140 to the impedance matching circuit 160 to perform the drying operation. The controller 300 may control the first switch SM to connect the second RF power supplier 150 to the impedance matching circuit 160 to perform the sterilizing operation.

The impedance matching circuit 160 may be provided as a circuit in which a plurality of inductors L, a plurality of capacitors C and a plurality of switches are electrically connected in series and/or parallel. The plurality of switches included in the impedance matching circuit 160 may be opened or closed under the control of the controller 300. As the plurality of switches are controlled, impedance matching may be performed. The impedance matching circuit 160 is illustrated in FIG. 9 as including three inductors L connected in parallel, three capacitors C connected in parallel and nine switches, but is not limited thereto. The structure of the impedance matching circuit 160 may be changed in various ways depending on the design.

The second switch SE1 and the third switch SE2 may be connected to the output end of the impedance matching circuit 160. The second switch SE1 may connect the impedance matching circuit 160 to the drying electrode 90. The third switch SE2 may connect the impedance matching circuit 160 to the sterilizing electrode 91. An inductor Ldr provided between the second switch SE1 and the drying electrode 90 may prevent a spark from occurring when the second switch SE1 is closed. An inductor Lst provided between the third switch SE2 and the sterilizing electrode 91 may prevent a spark from occurring when the third switch SE2 is closed.

To connect the plurality of drying electrodes 90 and the plurality of sterilizing electrodes 91 to the impedance matching circuit 160, the plurality of second switches SE1 and the plurality of third switches SE2 may be connected to the output end of the impedance matching circuit 160.

It is also possible that the impedance matching circuit 160 may be provided in a plural to correspond to the plurality of drying electrodes 90 and the plurality of sterilizing electrodes 91. For example, a single drying electrode 90, a single sterilizing electrode 91, and a single impedance matching circuit 160 may be provided in a set. Each of the plurality of impedance matching circuits 160 may be connected to the first RF power supplier 140 for the drying operation and to the second RF power supplier 150 for the sterilizing operation.

The controller 300 may control the impedance matching circuit 160 to match the output impedance of the first RF power supplier 140 and the electrode impedance of the drying electrode 90 to perform the drying operation. The impedance matching between the first RF power supplier 140 and the drying electrode 90 for the drying operation may be referred to as first impedance matching.

The controller 300 may control the impedance matching circuit 160 to match the output impedance of the second RF power supplier 150 and the electrode impedance of the sterilizing electrode 91 to perform the sterilizing operation. The impedance matching between the second RF power supplier 150 and the sterilizing electrode 91 for the sterilizing operation may be referred to as second impedance matching.

The dryer 1 may alternately perform the drying operation and the sterilizing operation. For this, the controller 300 may control the impedance matching circuit 160 to perform the second impedance matching after the drying operation and before the sterilizing operation. The controller 300 may control the impedance matching circuit 160 to perform the first impedance matching after the sterilizing operation and before the drying operation.

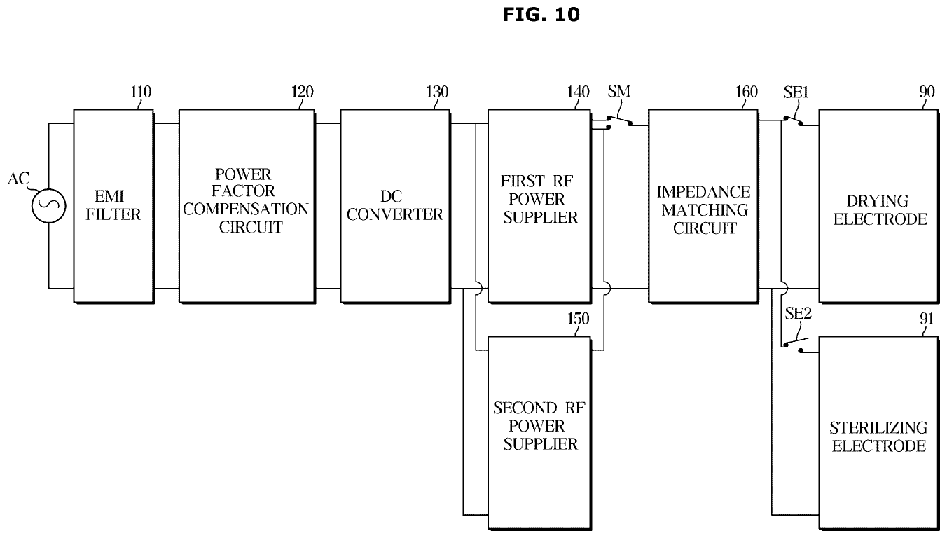

FIG. 10 illustrates a circuit structure of a dryer when the dryer performs a drying operation, according to one or more embodiments.

Referring to FIG. 10, the controller 300 of the dryer 1 may control the first switch SM, the second switch SE1, and the third switch SE2 to connect the first RF power supplier 140, the impedance matching circuit 160, and the drying electrode 90 to perform the drying operation.

The controller 300 may control the first switch SM to connect the first RF power supplier 140 to the impedance matching circuit 160 to perform the drying operation. The controller 300 may close the second switch SE1 to connect the impedance matching circuit 160 to the drying electrode 90. The controller 300 may open the third switch SE2 to disconnect the impedance matching circuit 160 from the sterilizing electrode 91.

Furthermore, the controller 300 may activate the first RF power suppler 140 and deactivate the second RF power supplier 150 during the drying operation. The controller 300 may control the first RF power supplier 140 to apply a first voltage and a first current to the drying electrode 90 during the drying operation. The first voltage and the first current may be applied to each of the plurality of drying electrodes 90. Accordingly, an electric field for drying the object may be produced in the drum 20 during the drying operation.

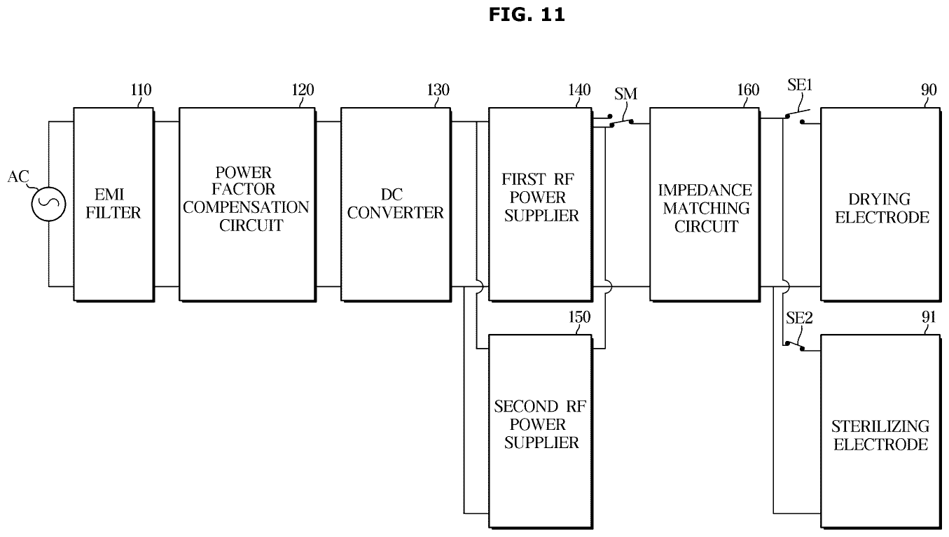

FIG. 11 illustrates a circuit structure of a dryer when the dryer performs a sterilizing operation, according to one or more embodiments.

Referring to FIG. 11, the controller 300 of the dryer 1 may control the first switch SM, the second switch SE1 and the third switch SE2 to connect the second RF power supplier 150, the impedance matching circuit 160, and the sterilizing electrode 91 to perform the sterilizing operation.

The controller 300 may control the first switch SM to connect the second RF power supplier 150 to the impedance matching circuit 160 to perform the sterilizing operation. The controller 300 may open the second switch SE1 to disconnect the impedance matching circuit 160 from the drying electrode 90. The controller 300 may close the third switch SE2 to connect the impedance matching circuit 160 to the sterilizing electrode 91.

Furthermore, the controller 300 may deactivate the first RF power suppler 140 and activate the second RF power supplier 150 during the sterilizing operation. The controller 300 may control the second RF power supplier 150 to apply a second voltage and a second current to the sterilizing electrode 91 during the sterilizing operation. The second voltage and the second current may be applied to each of the plurality of sterilizing electrodes 91. Accordingly, an electric field for sterilizing the object may be produced in the drum 20 during the sterilizing operation.

The first voltage applied to the drying electrode 90 for the drying operation may be lower than the second voltage applied to the sterilizing electrode 91 for the sterilizing operation. The first current applied to the drying electrode 90 for the drying operation may be greater than the second current applied to the sterilizing electrode 91 for the sterilizing operation.

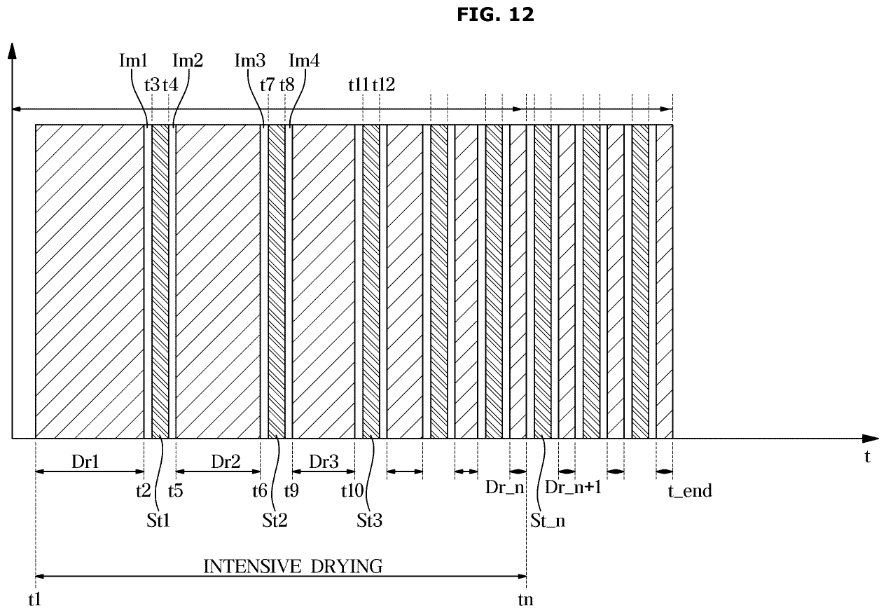

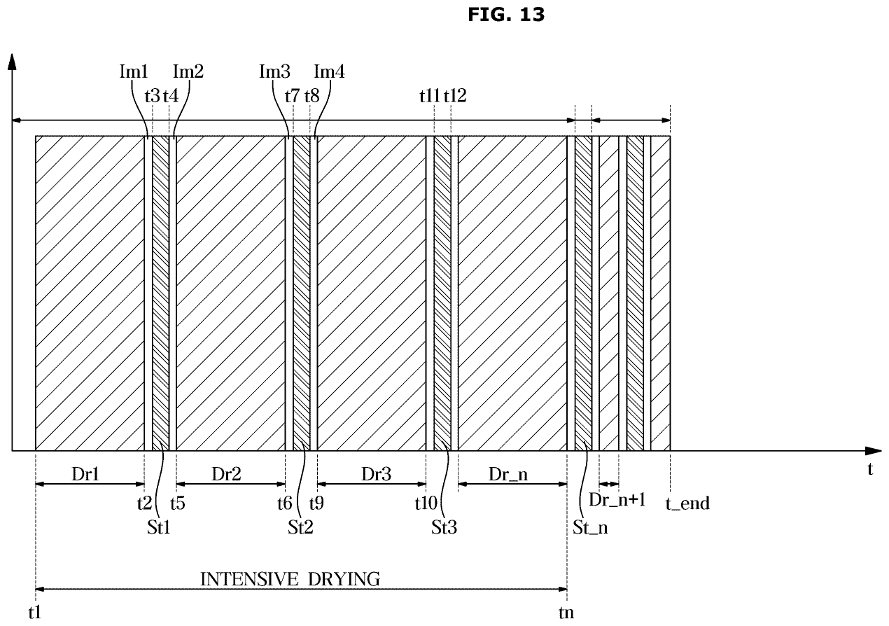

FIG. 12 is a graph for describing an example of how to control a dry time interval relating to a drying operation. FIG. 13 is a graph for describing another example of how to control a dry time interval relating to a drying operation.

As described above, the controller 300 of the dryer 1 may alternately perform the drying operation and the sterilizing operation multiple times. The whole operation time of the dryer 1 may be divided into a dry time and a sterilization time. The dry time may indicate a sum of dry time intervals of the plurality of drying operations. The sterilization time may indicate a sum of sterilization time intervals of the plurality of sterilizing operations. The dry time may be set to be longer than the sterilization time to maximize the dry efficiency.

Referring to FIGS. 12 and 13, the drying operation and the sterilizing operation may be alternately performed from a point in time, t1 at which the dryer 1 starts to operate to a point in time t_end at which the operation of the dryer 1 ends. That is, the drying operation and the sterilizing operation may be alternately performed repeatedly. For example, the drying operation may be performed from t1 to t2, and the sterilizing operation may be performed from t3 to t4. Impedance matching Im1 between the second RF power supplier 150 and the sterilizing electrode 91 may be performed between t2 and t3. Impedance matching may simply change inductance and capacitance of the impedance matching circuit 160, and thus, a time required for the impedance matching may be very short.

The sterilizing operation ends at t4, and impedance matching Im2 between the first RF power supplier 140 and the drying electrode 90 may be performed between t4 and t5. The drying operation may be performed again from t5 to t6. When the drying operation ends at t6, impedance matching Im3 between the second RF power supplier 150 and the sterilizing electrode 91 may be performed again between t6 and t7, and then the sterilizing operation may be performed from t7 to t8. When the sterilizing operation ends, impedance matching Im4 between the first RF power supplier 140 and the drying electrode 90 may be performed again between t8 and t9, and subsequently, the drying operation may be performed from t9 to t10.

An entire operation time of the dryer 1 from t1 to t_end may include the plurality of dry time intervals and the plurality of sterilization time intervals. The dryer 1 may control the dry time interval for each of the plurality of drying operations while alternately performing the plurality of drying operations and the plurality of sterilizing operations.

The moisture content of the object may be linearly or non-linearly reduced while the plurality of drying operations are performed. Moisture contained in the object may be removed quickly at the beginning of the drying, and an amount of change in moisture content of the object may gradually decrease and the change of the moisture content converges to 0 over time. Both the drying efficiency and the sterilization efficiency may increase by adjusting the dry time interval based on the change in moisture content.

For example, as shown in FIG. 12, the dryer 1 may linearly or non-linearly reduce the dry time interval during the intensive dry time from t1 to tn. Comparing among a first dry time interval Dr1 from t1 to t2, a second dry time interval Dr2 from t5 to t6, and a third dry time interval Dr3 from t9 to t10, the first dry time interval Dr1 may be the longest and the third dry time interval Dr3 may be the shortest. The second dry time interval Dr2 may be shorter than the first dry time interval Dr1 and longer than the third dry time interval Dr3. N drying operations may be performed within the intensive dry time. The first dry time interval Dr1 of the first drying operation may be set to be the longest and the n-th dry time interval Dr_n of the n-th drying operation may be set to be the shortest.

The dryer 1 may no longer reduce the dry time interval but keep the dry time interval constant after the intensive dry time passes. In other words, the dry time intervals of drying operations performed after tn may all be the same. Furthermore, the dry time intervals of drying operations performed after tn may be equal to the sterilization time interval. An (n+1)-th dry time interval Dr_n+1 of an (n+1)-th drying operation may be equal to an n-th dry time interval Dr_n.

During the whole operation time of the dryer 1, the plurality of sterilization time intervals may all be set to be the same. That is, the sterilization time interval may be kept constant. For example, in FIGS. 12 and 13, a first sterilization time interval St1 from t3 to t4, a second sterilization time interval St2 from t7 to t8, a third sterilization time interval St3 from t11 to t12 and an n-th sterilization time interval St_n after tn may be all the same. Furthermore, the n-th sterilization time interval St_n may be equal to the n-th dry time interval Dr_n.

The sterilization time interval is not limited to what are described above, and the plurality of sterilization time intervals may be adjusted as well.

In another example, as shown in FIG. 13, the controller 300 may keep the dry time interval constant during the preset intensive dry time, and reduce the dry time interval based on a lapse of the preset intensive dry time. Comparing among the first dry time interval Dr1, the second dry time interval Dr2, the third dry time interval Dr3 and the n-th dry time interval Dr_n in FIG. 13, the first dry time interval Dr1, the second dry time interval Dr2, the third dry time interval Dr3 and the n-th dry time interval Dr_n may be the same. In other words, the dry time intervals of n drying operations performed in the intensive dry time may all be set to be the same. Furthermore, the dry time interval of each of the plurality of drying operations performed during the intensive dry time may be greater than the sterilization time interval.

Comparing FIGS. 12 and 13, the numbers of times of performing the sterilizing operation in the intensive dry time may be different. Specifically, a greater number of sterilizing operations may be performed in the intensive dry time in FIG. 12. When an initial dry time interval is kept constant during the intensive dry time, the sterilization effect may be a bit reduced but the dry effect may be maximized.

The dryer 1 may reduce the dry time interval after a lapse of the intensive dry time. After tn, the n-th sterilization time interval St_n and the (n+)-th dry time interval Dr_n+1 may be the same.

In the meantime, the intensive dry time and the dry time interval may be adjusted based on the amount of the object or the user input. For example, when the amount of the object is relatively small or the sterilization intensity is set to be high according to a user input, the dryer 1 may linearly or non-linearly reduce the dry time interval in the intensive dry time as described in connection with FIG. 12. On the contrary, when the amount of the object is relatively large or the sterilization intensity is set to be low according to a user input, the dryer 1 may keep the dry time interval constant in the intensive dry time as described in connection with FIG. 13.

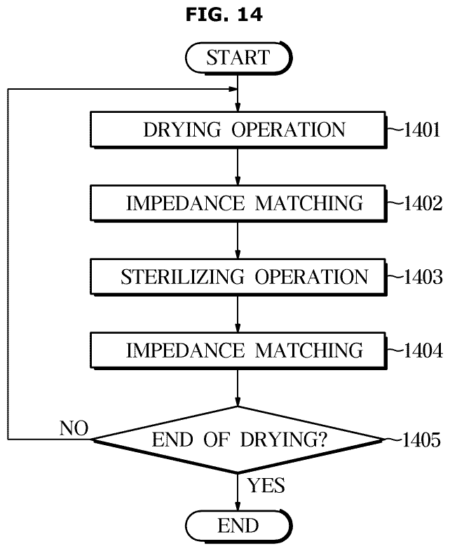

FIG. 14 is a flowchart describing a method of controlling a dryer, according to an embodiment.

Referring to FIG. 14, the dryer 1 may perform a drying operation to dry the object accommodated in the drum 20, in 1401. The controller 300 may control the first switch SM to connect the first RF power supplier 140 to the impedance matching circuit 160 to perform the drying operation. The controller 300 may close the second switch SE1 to connect the impedance matching circuit 160 to the drying electrode 90. The controller 300 may open the third switch SE2 to disconnect the impedance matching circuit 160 from the sterilizing electrode 91. The controller 300 may activate the first RF power suppler 140 and deactivate the second RF power supplier 150 during the drying operation. The drying operation may be performed during the dry time interval.

Although not shown, the dryer 1 may perform impedance matching (first impedance matching) to match the output impedance of the first RF power supplier 140 and the electrode impedance of the drying electrode 90 before performing the drying operation in 1401.

The dryer 1 may perform impedance matching (second impedance matching) to match the output impedance of the second RF power supplier 150 and the electrode impedance of the sterilizing electrode 91 before the sterilizing operation and after the drying operation, in 1402.

After the impedance matching between the second RF power supplier 150 and the sterilizing electrode 91, the dryer 1 may perform the sterilizing operation to sterilize the object, in 1403. The controller 300 may control the first switch SM to connect the second RF power supplier 150 to the impedance matching circuit 160 to perform the sterilizing operation. The controller 300 may open the second switch SE1 to disconnect the impedance matching circuit 160 from the drying electrode 90. The controller 300 may close the third switch SE2 to connect the impedance matching circuit 160 to the sterilizing electrode 91. Furthermore, the controller 300 may deactivate the first RF power suppler 140 and activate the second RF power supplier 150 during the sterilizing operation. The sterilizing operation may be performed during the sterilization time interval.

The dryer 1 may perform impedance matching (first impedance matching) again to match the output impedance of the first RF power supplier 140 and the electrode impedance of the drying electrode 90 after the sterilizing operation, in 1404.

The dryer 1 may determine whether the drying of the object ends, in 1405. For example, the controller 300 of the dryer 1 may determine a level of dryness of the object based on a change in a magnitude of the voltage detected from the drying electrode 90 and/or the sterilizing electrode 91 and/or a change in electrode impedance of the drying electrode 90 and/or the sterilizing electrode 91. The controller 300 may determine completion of the drying based on the level of dryness of the object reaching within a tolerance range of a preset reference dryness level. Furthermore, the controller 300 may determine completion of the drying when the electrode impedance of the drying electrode 90 and/or the sterilizing electrode 91 is greater than or equal to a preset threshold.

When the drying of the object is not completed, the dryer 1 may continue to perform the drying operation. The dryer 1 may alternately perform the drying operation and the sterilizing operation one or more times until completion of the drying is determined.

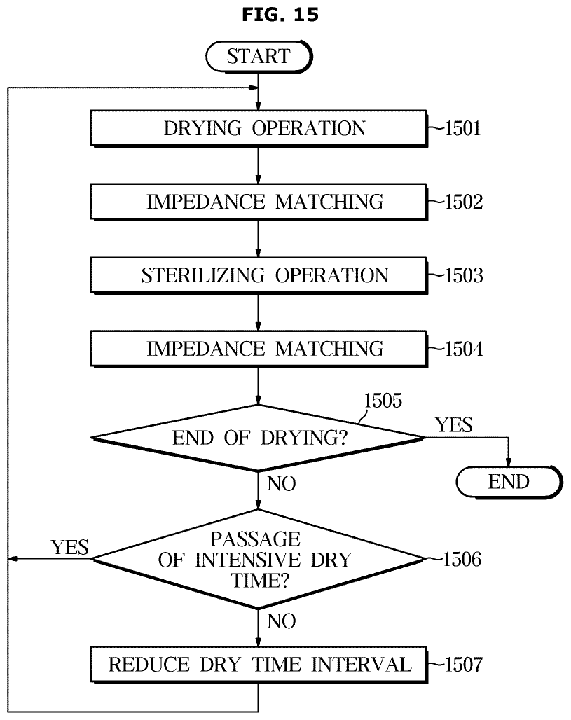

FIG. 15 is a flowchart describing an example of time control for a drying operation in a method of controlling the dryer as described in FIG. 14.

Referring to FIG. 15, operations 1501, 1502, 1503, 1504 and 1505 may be the same as operations 1401, 1402, 1403, 1404 and 1405 as described in FIG. 14. When it is determined that drying of the object is not completed after performing the drying operation during the dry time interval in 1505, the dryer 1 may determine whether an intensive dry time has passed in 1506.

When it is determined that the intensive dry time has not passed in 1506, the controller 300 of the dryer 1 may reduce the dry time interval of the drying operation in 1507. The controller 300 may linearly or non-linearly reduce the dry time interval of each of the plurality of drying operations performed during the intensive dry time. The controller 300 may keep the dry time interval of the drying operation performed after the passage of the intensive dry time constant. In other words, the dryer 1 may gradually reduce the dry time interval during the intensive dry time, and after the lapse of the intensive dry time, may not reduce the dry time interval. Accordingly, the dryer 1 may increase both the dry efficiency and the sterilization efficiency.

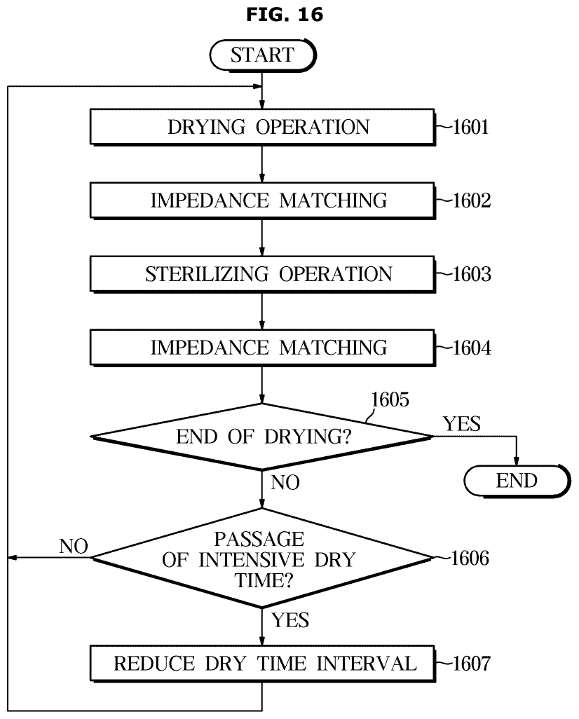

FIG. 16 is a flowchart describing another example of time control for a drying operation in the method of controlling the dryer as described in FIG. 14.

Referring to FIG. 16, operations 1601, 1602, 1603, 1604 and 1605 may be the same as operations 1401, 1402, 1403, 1404 and 1405 as described in FIG. 14. Operation 1606 may be the same as operation 1506 as described in FIG. 15.

The controller 300 of the dryer 1 may keep the dry time interval of each of the plurality of drying operations performed during the intensive dry time constant. The dry time intervals of n drying operations performed in the intensive dry time may all be set to be the same. In this case, the dry time interval of each of the plurality of drying operations performed during the intensive dry time may be longer than the sterilization time interval. The controller 300 may reduce the dry time interval of the drying operation performed after the passage of the intensive dry time in 1607.

According to an embodiment, a dryer 1 may include a drum; a plurality of drying electrodes separately arranged along a circumferential surface of the drum; a plurality of sterilizing electrodes arranged along the circumferential surface of the drum between the plurality of drying electrodes and having a size smaller than the plurality of drying electrodes; first and second RF power suppliers configured to generate RF signals, respectively; an impedance matching circuit configured to perform first impedance matching between the first RF power supplier and the plurality of drying electrodes or second impedance matching between the second RF power supplier and the plurality of sterilizing electrodes; a first switch configured to connect the impedance matching circuit to the first RF power supplier or the second RF power supplier; a second switch configured to connect the impedance matching circuit to the plurality of drying electrodes; a third switch configured to connect the impedance matching circuit to the plurality of sterilizing electrodes; and a controller configured to control the first RF power supplier, the second RF power supplier, the impedance matching circuit, the first switch, the second switch and the third switch to alternately perform a drying operation and a sterilizing operation.

The controller may alternately perform the drying operation and the sterilizing operation multiple times (e.g., two or more times). The controller may adjust a dry time interval for each of a plurality of drying operations while alternately performing the plurality of drying operations and a plurality of sterilizing operations.

The controller may linearly or non-linearly reduce the dry time interval for each drying operation performed during a preset intensive dry time, and keep the dry time interval constant based on a lapse of the preset intensive dry time.

The controller may keep the dry time interval constant for each drying operation performed during the preset intensive dry time, and reduce the dry time interval based on a lapse of the preset intensive dry time.

The controller may activate the first RF power supplier and deactivate the second RF power supplier in the drying operation. The controller may deactivate the first RF power supplier and activate the second RF power supplier in the sterilizing operation.

The controller may control the first RF power supplier to apply a first voltage and a first current to the plurality of drying electrodes in the drying operation. The controller may control the second RF power supplier to apply a second voltage and a second current to the plurality of sterilizing electrodes in the sterilizing operation. The first voltage may be lower than the second voltage, and the first current may be greater than the second current.

The controller may control the impedance matching circuit to perform the second impedance matching before the sterilizing operation after the drying operation. The controller may control the impedance matching circuit to perform the first impedance matching before the drying operation after the sterilizing operation. The controller may control the first switch, the second switch and the third switch to connect the first RF power supplier, the impedance matching circuit and the plurality of drying electrodes to perform the drying operation. The controller may control the first switch, the second switch and the third switch to connect the second RF power supplier, the impedance matching circuit and the plurality of sterilizing electrodes to perform the sterilizing operation.

The controller may control the first switch to connect the first RF power supplier to the impedance matching circuit, close the second switch to connect the impedance matching circuit to the plurality of drying electrodes, and open the third switch to disconnect the impedance matching circuit from the plurality of sterilizing electrodes to perform the drying operation.

The controller may control the first switch to connect the second RF power supplier to the impedance matching circuit, open the second switch to disconnect the impedance matching circuit from the plurality of drying electrodes, and close the third switch to connect the impedance matching circuit to the plurality of sterilizing electrodes.

A first area of each of the plurality of drying electrodes may be set to be larger than a second area of each of the plurality of sterilizing electrodes.

First thickness of each of the plurality of drying electrodes may be set to be greater than second thickness of each of the plurality of sterilizing electrodes.

Provided is a method of controlling a dryer including a drum, a plurality of drying electrodes separately arranged along a circumferential surface of the drum and a plurality of sterilizing electrodes arranged along the circumferential surface of the drum between the plurality of drying electrodes, wherein the dryer may include a first switch configured to connect an impedance matching circuit to a first RF power supplier or a second RF power supplier; a second switch configured to connect the impedance matching circuit to the plurality of drying electrodes; and a third switch configured to connect the impedance matching circuit to the plurality of sterilizing electrodes.

According to an embodiment, a method of controlling a dryer includes performing a drying operation by controlling the first switch, the second switch and the third switch to connect the first RF power supplier, the impedance matching circuit and the plurality of drying electrodes; performing a sterilizing operation by controlling the first switch, the second switch and the third switch to connect the second RF power supplier, the impedance matching circuit and the plurality of sterilizing electrodes; and alternately performing the drying operation and the sterilizing operation.

The alternately performing of the drying operation and the sterilizing operation may include adjusting a dry time interval for each of the plurality of drying operations while alternately performing a plurality of drying operations and a plurality of sterilizing operations.

The adjusting of the dry time interval for each of the plurality of drying operations may include linearly or non-linearly reducing the dry time interval during a preset intensive dry time; and keeping the dry time interval constant based on a lapse of the preset intensive dry time.

The adjusting of the dry time interval for each of the plurality of drying operations may include keeping the dry time interval constant during a preset intensive dry time; and reducing the dry time interval based on a lapse of the preset intense dry time.

The performing of the drying operation may include controlling the first RF power supplier to apply a first voltage and a first current to the plurality of drying electrodes. The performing of the sterilizing operation may include controlling the second RF power supplier to apply a second voltage and a second current to the plurality of sterilizing electrodes. The first voltage may be lower than the second voltage, and the first current may be higher than the second current.

The alternately performing the drying operation and the sterilizing operation may include controlling the impedance matching circuit to perform first impedance matching between the first RF power supplier and the plurality of drying electrodes after the drying operation that has been performed and before the sterilizing operation that is to be performed; and controlling the impedance matching circuit to perform second impedance matching between the second RF power supplier and the plurality of sterilizing electrodes after the sterilizing operation that has been performed and before the drying operation that is to be performed.

The performing of the drying operation may include controlling the first switch to connect the first RF power supplier to the impedance matching circuit; closing the second switch to connect the impedance matching circuit to the plurality of drying electrodes; and opening the third switch to disconnect the impedance matching circuit from the plurality of sterilizing electrodes.

The performing of the sterilizing operation may include controlling the first switch to connect the second RF power supplier to the impedance matching circuit; opening the second switch to disconnect the impedance matching circuit from the plurality of drying electrodes; and closing the third switch to connect the impedance matching circuit to the plurality of sterilizing electrodes.

A dryer and a method of controlling the same in the disclosure may perform both a drying operation and a sterilizing operation by using a drying electrode and a sterilizing electrode arranged separately.

The dryer and a method of controlling the same in the disclosure may provide power suitable for drying an object and power suitable for sterilizing the object.

The dryer and a method of controlling the same in the disclosure may maximize the efficiency of drying the object and attaining an effect of sterilizing the object. Along with the sterilizing effect, a deodorization effect may also be attained.

The example embodiments of the disclosure may be implemented in a form of a storage medium for storing instructions to be carried out by a computer. The instructions may be stored in a form of program codes, and when executed by a processor, may generate program modules to perform operation in the example embodiments of the disclosure.

The machine-readable storage medium may be provided in a form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

The aforementioned methods according to the one or more example embodiments of the disclosure may be provided in a computer program product. The computer program product may be a commercial product that may be traded between a seller and a buyer. The computer program product may be distributed in a form of a storage medium (e.g., a compact disc read only memory (CD-ROM)), through an application store (e.g., Play Store™), directly between two user devices (e.g., smart phones), or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

The example embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A dryer comprising:
a drum;
a plurality of drying electrodes arranged along a circumferential surface of the drum;
a plurality of sterilizing electrodes arranged along the circumferential surface of the drum between the plurality of drying electrodes;
a first radio frequency (RF) power supplier and a second RF power supplier configured to generate RF signals, respectively;
an impedance matching circuit configured to perform a first impedance matching between the first RF power supplier and the plurality of drying electrodes or a second impedance matching between the second RF power supplier and the plurality of sterilizing electrodes;
a first switch configured to connect the impedance matching circuit to the first RF power supplier or the second RF power supplier;
a second switch configured to connect the impedance matching circuit to the plurality of drying electrodes;
a third switch configured to connect the impedance matching circuit to the plurality of sterilizing electrodes; and
a controller configured to control the first RF power supplier, the second RF power supplier, the impedance matching circuit, the first switch, the second switch, and the third switch to alternately perform a drying operation and a sterilizing operation.

2. The dryer of claim 1, wherein the controller is further configured to:
alternately perform the drying operation and the sterilizing operation two or more times; and
adjust a dry time interval for each drying operation of a plurality of drying operations while alternately performing the plurality of drying operations and a plurality of sterilizing operations.

3. The dryer of claim 2, wherein the controller is further configured to:
linearly or non-linearly reduce the dry time interval for each drying operation performed during a preset intensive dry time; and
maintain the dry time interval constant for each drying operation performed after a lapse of the preset intensive dry time.

4. The dryer of claim 2, wherein the controller is further configured to:
maintain the dry time interval constant for each drying operation performed during a preset intensive dry time; and
reduce the dry time interval for each drying operation performed after a lapse of the preset intensive dry time.

5. The dryer of claim 1, wherein the controller is further configured to:
activate the first RF power supplier and deactivate the second RF power supplier in the drying operation; and
deactivate the first RF power supplier and activate the second RF power supplier in the sterilizing operation.

6. The dryer of claim 1, wherein the controller is further configured to:
control the first RF power supplier to apply a first voltage and a first current to the drying electrode in the drying operation, and
control the second RF power supplier to apply a second voltage and a second current to the sterilizing electrode in the sterilizing operation, and
wherein the first voltage is lower than the second voltage, and the first current is greater than the second current.

7. The dryer of claim 1, wherein the controller is further configured to:
control the impedance matching circuit to perform the second impedance matching after the drying operation that has been performed and before the sterilizing operation that is to be performed, and
control the impedance matching circuit to perform the first impedance matching after the sterilizing operation that has been performed and before the drying operation that is to be performed.

8. The dryer of claim 1, wherein the controller is further configured to:
control the first switch, the second switch, and the third switch to connect the first RF power supplier, the impedance matching circuit, and the plurality of drying electrodes to perform the drying operation; and
control the first switch, the second switch, and the third switch to connect the second RF power supplier, the impedance matching circuit, and the plurality of sterilizing electrodes to perform the sterilizing operation.

9. The dryer of claim 8, wherein the controller is further configured to control the first switch to connect the first RF power supplier to the impedance matching circuit, close the second switch to connect the impedance matching circuit to the plurality of drying electrodes, and open the third switch to disconnect the impedance matching circuit from the plurality of sterilizing electrodes, to perform the drying operation.

10. The dryer of claim 8, wherein the controller is further configured to control the first switch to connect the second RF power supplier to the impedance matching circuit, open the second switch to disconnect the impedance matching circuit from the plurality of drying electrodes, and close the third switch to connect the impedance matching circuit to the plurality of sterilizing electrodes, to perform the sterilizing operation.

11. The dryer of claim 1, wherein a first area of each drying electrode of the plurality of drying electrodes is set to be larger than a second area of each sterilizing electrode of the plurality of sterilizing electrodes.

12. The dryer of claim 1, wherein first thickness of each of the plurality of drying electrodes is set to be greater than second thickness of each of the plurality of sterilizing electrodes.

13. A method of controlling a dryer including a drum, a plurality of drying electrodes arranged along a circumferential surface of the drum, and a plurality of sterilizing electrodes arranged along the circumferential surface of the drum between the plurality of drying electrodes, wherein the dryer comprises a first switch configured to connect an impedance matching circuit to a first radio frequency (RF) power supplier or a second RF power supplier; a second switch configured to connect the impedance matching circuit to the plurality of drying electrodes; and a third switch configured to connect the impedance matching circuit to the plurality of sterilizing electrodes, the method comprising:
performing a drying operation by controlling the first switch, the second switch, and the third switch to connect the first RF power supplier, the impedance matching circuit, and the plurality of drying electrodes;
performing a sterilizing operation by controlling the first switch, the second switch, and the third switch to connect the second RF power supplier, the impedance matching circuit, and the plurality of sterilizing electrodes; and
alternately performing the drying operation and the sterilizing operation.

14. The method of claim 13, wherein the alternately performing comprises:
adjusting a dry time interval for each of a plurality of drying operations while alternately performing the plurality of drying operations and a plurality of sterilizing operations.

15. The method of claim 14, wherein the adjusting the dry time interval comprises:
linearly or non-linearly reducing the dry time interval for each drying operation performed during a preset intensive dry time; and
maintaining the dry time interval constant based on a lapse of the preset intensive dry time.
